(19) United States
(12) Patent Application Publication
(10) Pub. No.: US 2014/0199432 A1
(43) Pub. Date: Jul. 17, 2014

(54) ALKALINE COMPOSITIONS

(71) Applicant: Richard Alexander SCHMOTTER, San Francisco, CA (US)

(72) Inventor: Richard Alexander SCHMOTTER, San Francisco, CA (US)

(21) Appl. No.: 14/164,466

(22) Filed: Jan. 27, 2014

Related U.S. Application Data
(60) Provisional application No. 61/916,187, filed on Dec. 14, 2013.
(60) Provisional application No. 61/733,729, filed on Dec. 5, 2012.

(51) Int. Cl. A23L 2/02; A23L 2/52

(52) U.S. Cl. CPC A23L 2/02; A23L 2/52
USPC 426/2; 426/648; 426/599

(57) ABSTRACT

An alkaline sports drink that utilizes phosphate buffer to achieve a pH of 7.4 (+/−0.3) for the purpose of preventing dental caries, improving physical performance, and benefiting overall health, is disclosed. This beverage product is stable at an alkaline pH, which is beneficial for oral health and the use of phosphate buffer increases physical performance by increasing muscle oxygen availability. The product is beneficial to overall health by buffering harmful acidic metabolites and aiding in their excretion from the body.

### CROSS-REFERENCE

This application claims priority to U.S. Provisional Patent Application No. 61/916,187, filed Dec. 14, 2013, and U.S. Provisional Patent Application 61/733,729, filed Dec. 5, 2012, both of which are incorporated herein by reference in their entireties.

### BACKGROUND OF THE INVENTION

Problem Solved: Prevents dental caries disease. Improves oxygen delivery in body. Buffers acidic metabolites. This patent is for the use of a phosphate buffering system to achieve a beverage pH of 7.4 (+/−0.3).

Other sports drinks are acidic. The consumption of acidic beverages (below pH 5.5) demineralizes the teeth leading to dental caries. The acidic beverages also contribute to increased dietary acid load, causing increased physical fatigue, and negatively affecting overall health.

This beverage product is stable at an alkaline pH of 7.4 (+/−0.3), which is beneficial for oral health and the use of phosphate buffer increases physical performance by increasing oxygen delivery to tissues and buffering acidic metabolites.

### DETAILED DESCRIPTION OF THE INVENTION

As stated above, the beverage prevents dental caries disease, improves oxygen delivery in body, and buffers acidic metabolites. The invention claimed here solves these problems associated with sports drinks.

This beverage is alkaline, utilizing dipotassium phosphate buffer to achieve a stable alkaline state of pH 7.4 (+/−0.3). The alkalinity prevents tooth demineralization and promotes healthy oral micro flora, decreasing dental caries disease. The use of dipotassium phosphate to stabilize the beverage at an alkaline pH causes alkalizing effects on the blood, acting on hemoglobin and allowing for increased oxygen delivery to tissues. The alkalinity in combination with high potassium concentration causes increased bicarbonate secretion into the blood by parietal cells in the wall of the stomach. This causes neutralization and excretion of harmful acidic metabolites in the blood. The high phosphate concentration acts as a urinary buffer, allowing for increased acid excretion via the urinary system and long term control of acid imbalance (which is detrimental to physical performance and overall systemic health).

The claimed invention differs from those that currently exist. This is the first sports drink that is alkaline rather than acidic, preventing the oral and systemic problems that occur with acidic beverage consumption. This beverage also utilizes a phosphate buffering system to naturally increase the energy producing ability of cells and allow for more oxygen delivery to peripheral tissues.

This invention is an improvement on what currently exists. This is the first sports drink that is alkaline rather than acidic, preventing the oral and systemic problems that occur with acidic beverage consumption. This beverage also utilizes a phosphate buffering system shown to naturally increase 2, 3 Bisphosphoglycerate in the blood and allow for more oxygen delivery to peripheral tissues.

Acids contacting the teeth directly demineralize the teeth leading to cavity formation. Acidic beverages increase dietary acid load, leading to decreased physical performance and systemic health complications.

This beverage product is stable at an alkaline pH of 7.4 (+/−0.3), which is beneficial for oral health and the specific use of phosphate buffer increases physical performance.

### The Version of The Invention Discussed Here Includes:

1. Dipotassium phosphate

2. aloe vera juice

3. agave nectar

4. magnesium chloride

5. ascorbic acid

6. natural flavors

### Relationship Between The Components:

The dipotassium phosphate (1) acts as the buffering agent, allowing for an alkaline pH of 7.4 (+/−0.3). The Aloe Vera juice (2) acts as a source of nutrients necessary for optimal health and performance. The agave nectar (3) is the source of carbohydrate for optimal sustained energy with a low glycemic index. The magnesium chloride (4) is for fortification of magnesium for increased nutrient absorption and proper cell function. The ascorbic acid (5) is for added antioxidant and increased immune function. The natural flavors (6) are for flavor profile.

### How The Invention Works:

The use of a phosphate buffer system to achieve a stable pH of 7.4 (+/−0.3), in context of a sports drink is unique. The buffer system at pH 7.4 (+/−0.3) raises the oral pH and promotes tooth remineralization. The digestion of dipotassium phosphate in this form occurs in the stomach and small intestine. In the stomach, potassium is actively absorbed by the potassium/hydrogen exchange mechanism, producing bicarbonate ion and causing an “alkaline tide” and beneficial alkalization of the blood system (offsetting dietary and metabolic acidosis). The absorption of phosphate in the small intestine allows for increased 2, 3 bisphosphoglycerate in the blood and decreases oxygen affinity to hemoglobin. This allows for increased oxygen delivery to peripheral tissues and increased physical performance.

### How To Make The Invention:

Mix ingredients with purified water in sterile environment, then process through sterilization unit and bottle in aseptic facility.

Phosphate is necessary for achieving a stable pH of 7.4 (+/−0.3). The aloe vera, agave nectar, magnesium chloride, and natural flavors are optional and variable.

Any ingredient may be manipulated in concentration to achieve a similar function. An additional ingredient may be added or a non-essential ingredient may be removed or altered. The phosphate buffer can be modified in concentration, or grouped with another acid or base to elicit similar functionality at a pH slightly different than the ideal 7.4.

### How To Use The Invention:

For use of this beverage, consume on a regular basis with increased consumption in days leading up to physical performance event. Ideal dosage is 1 to 2 bottles per day regularly, with up to 4 bottles per day within 5 days of an event. Effects can be seen however by replacing any beverage with this product. In this case, customer should drink desired amount (serving size 8 oz) before and during exercise, or at any time for general hydration.

1. A composition comprising:
a. dipotassium phosphate; and
b. a carbohydrate characterized by a low glycemic index.

2. The composition of claim 1, wherein the carbohydrate characterized by a low glycemic index is agave nectar.

3. The composition of claim 1, further comprising aloe vera juice, magnesium chloride, ascorbic acid, water, or at least one flavoring, or any combinations thereof.

4. The composition of claim 1, further comprising aloe vera juice, magnesium chloride, ascorbic acid, water, and at least one flavoring.

5. The composition of claim 1, wherein the composition has a pH between about 7.1 to about 7.7.

6. The composition of claim 1, wherein the composition has a pH of about 7.4.

7. A composition comprising:
a. dipotassium phosphate; and
b. aloe vera juice.

8. The composition of claim 7, further comprising a carbohydrate characterized by a low glycemic index.

9. The composition of claim 8, wherein the carbohydrate characterized by a low glycemic index is agave nectar.

10. The composition of claim 7, further comprising magnesium chloride, ascorbic acid, water, or at least one flavoring, or any combinations thereof.

11. The composition of claim 7, further comprising a carbohydrate characterized by a low glycemic index, magnesium chloride, ascorbic acid, water, and at least one flavoring.

12. The composition of claim 7, further comprising agave nectar, magnesium chloride, ascorbic acid, water, and at least one flavoring.

13. The composition of claim 7, wherein the composition has a pH between about 7.1 and about 7.7.

14. The composition of claim 7, wherein the composition has a pH of about 7.4.

15. A composition comprising:
a. dipotassium phosphate;
b. aloe vera juice;
c. agave nectar;
d. magnesium chloride;
e. ascorbic acid; and
f. at least one flavoring.

16. A method of increasing oxygen delivery to tissue, comprising administering a composition comprising dipotassium phosphate.

17. The method of claim 16, wherein the composition further comprises a carbohydrate characterized by a low glycemic index, aloe vera juice, magnesium chloride, ascorbic acid, water, and at least one flavoring.

18. The method of claim 17, wherein the carbohydrate characterized by a low glycemic index is agave nectar.

19. The method of claim 16, wherein the pH of the composition is about 7.1 to about 7.7.

20. The method of claim 16, wherein the pH of the composition is about 7.4.
